(19) United States
(12) Patent Application Publication
(10) Pub. No.: US 2014/0233689 A1
(43) Pub. Date: Aug. 21, 2014

(54) Water Jet Peening Apparatus and Water Jet Peening Method

(71) Applicant: Hitachi-GE Nuclear Energy, Ltd., Hitachi-shi (JP)

(72) Inventors: Noboru SAITO, Tokyo (JP); Hisamitsu HATOU, Tokyo (JP); Koichi KUROSAWA, Hitachi (JP); Fujio YOSHIKUBO, Hitachi (JP); Ren MORINAKA, Hitachi (JP); Ryuji KIMURA, Hitachi (JP)

(73) Assignee: Hitachi-GE Nuclear Energy, Ltd., Hitachi-shi (JP)

(21) Appl. No.: 14/180,608

(22) Filed: Feb. 14, 2014

(30) Foreign Application Priority Data
Feb. 15, 2013 (JP) 2013-028108

(51) Int. Cl. G21C 19/00

(52) U.S. Cl. CPC G21C 19/00
USPC 376/316

(57) ABSTRACT

In a water jet peening apparatus, a high-pressure under-water pump is installed on an upper end of a casing and an injection nozzle drive mechanism equipped with an injection nozzle is attached to the casing. A high-pressure hose whose one end is connected to the high-pressure under-water pump is disposed in the casing and the other end of the high-pressure hose is connected to the injection nozzle. The casing is seated at an upper end of a control rod drive mechanism housing and the high-pressure under-water pump is driven. The high-pressure water pressurized by the high-pressure under-water pump is supplied to the injection nozzle through the high-pressure hose in the casing and is jetted toward the weld portion between the control rod drive mechanism housing and a stub tube. The time required for a water jet peening operation can be shortened.

### CLAIM OF PRIORITY

The present application claims priority from Japanese Patent application serial no. 2013-028108, filed on Feb. 15, 2013, the content of which is hereby incorporated by reference into this application.

### BACKGROUND OF THE INVENTION

1. Technical Field

The present invention relates to a water jet peening apparatus and a water jet peening method, and more particularly to a water jet peening apparatus and a water jet peening method suitably applicable to a reactor internal of a reactor.

2. Background Art

For the purpose of improvement of fatigue strength and stress corrosion cracking resistance of a metallic material, a method of compressing residual stress of material surface is used in some cases. One of the residual stress improving methods is water jet peening (hereinafter referred to as WJP) using a cavitation jet. The WJP is a technique that the cavitation jet including fine numberless cavities is generated in water by jetting a high-pressure water from an injection nozzle into the water, and then shock waves or a micro jet which are generated when the cavities are collapsed acts on the surface of the structural member made of a metal in contact with the water, causing the surface of the structural member to plastically deform minutely. The plastically deformed portion of the structural member is elastically restricted from the circumference, so that the compressive residual stress is given to a surface of the structural member.

On the other hand, the stress corrosion cracking generated on the reactor internal of the reactor is a notable material damage for safety's sake of the equipment and not only the investigation of the materials at the time of manufacture, structure design, and manufacture conditions but also preventive maintenance after manufacture are important. The WJP uses water as a medium, so that there is no need to consider residual foreign bodies and it is fit as a preventive maintenance technique of the reactor internal of the reactor, which is strict in foreign bodies management.

When applying the WJP to the reactor internal in a reactor pressure vessel of a boiling water nuclear power plant, a closure head of the reactor pressure vessel is removed, and the steam dryer, steam separator, fuel assemblies, and control rods are taken out sequentially from the reactor pressure vessel, and then a water jet peening apparatus (hereinafter referred to as a WJP apparatus) is hanged by a ceiling crane installed on a ceiling of a reactor building (or a fuel handling machine installed on an operating floor in the reactor building), and the ceiling crane (or the fuel handling machine) is moved straight and sideways. Furthermore, the WJP apparatus is lowered and is disposed in the neighborhood of a WJP execution object in the reactor pressure vessel. The WJP apparatus has a drive mechanism for positioning the injection nozzle against an execution objective portion of the WJP execution object. The injection nozzle is installed at a tip of the drive mechanism. After the WJP apparatus is disposed in the neighborhood of the WJP execution object in the reactor pressure vessel, the drive mechanism adjusts an injection angle and an injection position (height) of the injection nozzle, and high-pressure water supplied from a high-pressure pump installed on the operating floor in the reactor building is injected from the injection nozzle, thereby executing WJP in the execution objective portion of the WJP execution object. The high-pressure water is introduced to the injection nozzle of the WJP apparatus from a high-pressure pump through a high-pressure hose, though in the conventional technique, the high-pressure pump, as mentioned above, is installed on the operating floor together with a control apparatus for controlling the WJP apparatus. Further, the water pressurized by the high-pressure pump is generally supplied from the make-up water system in the reactor building, though it is also proposed to use the reactor water as the pressurizing water.

To pressurize the reactor water by the high-pressure pump and supply it to the injection nozzle of the WJP apparatus is proposed in Japanese Patent No. 2859125. In the WJP method described in Japanese Patent No. 2859125, the WJP apparatus is attached to the control rod drive mechanism housing installed passing through a bottom head of the reactor pressure vessel which is a WJP execution object and the injection nozzle of the WJP apparatus rotates around the control rod drive mechanism housing while the injection nozzle of the WJP apparatus is jetted the high-pressure water. The high-pressure water supplied to the injection nozzle is generated by pressurizing the reactor water purified by the filter by the driven high-pressure pump. This high-pressure water is supplied to the injection nozzle from the high-pressure pump. The injection flow of high-pressure water from the injection nozzle includes cavities and the shock waves generated due to the collapse of the cavities are impacted on a surface of the weld portion between the control rod drive housing and the stub tube attached to the reactor pressure vessel. In this manner, the WJP is executed on the surface of the weld portion and the compressive residual stress is given to that surface.

Japanese Patent Laid-Open No. 63 (1988)-34024 describes a top guide processing apparatus. A water injection mechanism of the top guide processing apparatus is disposed in the position of the top guide in the reactor pressure vessel. Water is filled in the reactor pressure vessel and a reactor well positioned right above the reactor pressure vessel. The water injection mechanism has a jet outlet and the water supplied from an under-water pump is jetted from the jet outlet toward a processing surface of the top guide. Chips generated due to processing by the water flow jetted from the jet outlet of the water injection mechanism are sucked in together with the reactor water by the under-water pump disposed in the water in the reactor well and are introduced to the filter installed in the fuel storage pool to be removed. The reactor water passing through the filter is discharged into the fuel storage pool.

### CITATION LIST

### Patent Literature

[Patent Literature 1] Japanese Patent No. 2859125
[Patent Literature 2] Japanese Patent Laid-Open No. 63 (1988)-34024

### SUMMARY OF THE INVENTION

### Technical Problem

The time required for operation of WJP execution in the nuclear power plant is desired to be shortened. For example, the WJP execution for the reactor internal in the reactor pressure vessel of the boiling water reactor power plant is executed during the periodic inspection term, so that if the WJP operation time becomes longer, the periodic inspection term is prolonged and there is a risk resulting in a reduction of an operation rate of the boiling water reactor power plant. Therefore, the time required for the operation of WJP execution is desired to be shortened more.

As described in Japanese Patent No. 2859125, in conventional WJP apparatuses, the high-pressure pump for supplying high-pressure water to the injection nozzle is installed on the operating floor and from the high-pressure pump up to the injection nozzle arranged in the neighborhood of the WJP execution objective portion of the WJP execution object, the high-pressure water is supplied through a long high-pressure hose.

The inventors investigated the time reduction in WJP execution operation and as a result, found that there will be a room for shortening WJP execution operation time by shortening the long high-pressure hose. Particularly, in the boiling water reactor power plant, the WJP apparatus is hanged by the ceiling crane, falls down in the reactor well from the operating floor, reaches inside the reactor pressure vessel, and is descended down to the neighborhood of the reactor internal which is a WJP execution object in the reactor pressure vessel. The high-pressure hose also falls down in correspondence to such a descent of the WJP apparatus. However, the descending time of the WJP apparatus cannot be shortened due to the restriction of the motion of the high-pressure hose because a high-pressure hose of 50 to 100 mm or so in length is hardly bent with high strength to ensure the pressure resistance. As a consequence, a considerable amount of time is required until the time when the WJP apparatus is lowered to the neighborhood of the reactor internal which is a WJP execution object. In addition, after the WJP execution for the reactor internal is finished, a considerable amount of time is also required in moving above the water surface of the cooling water in the reactor well to collect the WJP apparatus.

An object of the present invention is to provide a water jet peening apparatus and a water jet peening method capable of shortening the time required for water jet peening operation.

### Solution to Problem

A feature of the present invention for attaining the above object is that a casing, a high-pressure under-water pump installed on the casing, an injection nozzle to which water pressurized by the high-pressure under-water pump is supplied, and an injection nozzle moving apparatus installed in the casing for moving the injection nozzle.

The high-pressure under-water pump is installed on the casing where the injection nozzle is installed, so that the water jet peening apparatus having the high-pressure under-water pump and casing can be moved fast. Therefore, it is possible to shorten both the time required to set a water jet peening apparatus at the position of the water jet peening execution object in a reactor pressure vessel and the time required to collect the water jet peening apparatus from the reactor pressure vessel after end of the water jet peening operation. Therefore, the time required for the water jet peening operation for the water jet peening execution object can be shortened.

### Advantageous Effect of the Invention

According to the present invention, the time required for water jet peening operation can be shortened.

### BRIEF DESCRIPTION OF THE DRAWINGS

FIG. 1 is a structural diagram of a water jet peening apparatus according to embodiment 1 which is a preferable embodiment of the present invention.

FIG. 2 is a side view showing a water jet peening apparatus shown in FIG. 1.

FIG. 3 is an enlarged longitudinal sectional view showing revolution mechanism section and bearing section shown in FIG. 2.

FIG. 4 is an enlarged view showing a lower internal structure of a water jet peening apparatus shown in FIG. 2.

FIG. 5 is an enlarged view showing an upper structure of a water jet peening apparatus shown in FIG. 2.

FIG. 6 is a plan view showing an attachment structure of a water jet peening apparatus to a core plate.

FIG. 7 is a sectional view taken along a line VII-VII of FIG. 6.

FIG. 8 is a plan view showing another example of an attachment structure of a water jet peening apparatus to a core plate.

FIG. 9 is a sectional view taken along a line IX-IX of FIG. 8.

FIG. 10 is an enlarged view showing a X portion shown in FIG. 8.

FIG. 11 is a plan view showing still another example of an attachment structure of a water jet peening apparatus to a core plate.

FIG. 12 is a sectional view taken along a line XII-XII of FIG. 11.

FIG. 13 is an enlarged view showing a XIII portion shown in FIG. 11.

FIG. 14 is an explanatory drawing showing an experiment executed to confirm residual stress improvement effect (effective residual stress improvement range) of water jet peening.

FIG. 15 is a characteristic drawing showing a relation between distance from an execution center C and residual stress of a surface of a test piece after water jet peening, the relation showing an example of residual stress measurement results of the test piece surface after the water jet peening operation.

FIG. 16 is a characteristic drawing showing a relation between an injection flow rate Q of high-pressure pump with a power requirement of 15 kW and injection pressure P.

FIG. 17 is a characteristic drawing showing a relation between a required power E of a high-pressure pump and a width W of effective residual stress improvement.

FIG. 18 is a characteristic diagram showing the relation between a required power E of a high-pressure pump and a width ΔW per 1 kW of effective residual stress improvement.

FIG. 19 is a side view showing a water jet peening apparatus according to embodiment 2 which is another preferable embodiment of the present invention.

FIG. 20 is an explanatory drawing showing a support method for a water jet peening apparatus shown I FIG. 19.

### DETAILED DESCRIPTION OF THE PREFERRED EMBODIMENTS

As mentioned before, the inventors found that the WJP execution operation time can be shortened by shortening the high-pressure hose for connecting the high-pressure pump installed on the operating floor and the injection nozzle set at the neighborhood of the WJP execution object in the reactor pressure vessel. And, the inventors investigated a structure of a water jet peening apparatus (hereinafter referred to as a WJP apparatus) capable of shortening the high-pressure hose and as a result, concluded that the high-pressure pump should be installed on the casing included in the WJP apparatus having the injection nozzle.

However, when attaching the high-pressure pump to the casing of the WJP apparatus, unlike the case that the high-pressure pump is installed on the surface of the operating floor, a required power of the high-pressure pump needs to be low. Particularly, when executing the water jet peening (WJP) for a weld portion between a stub tube and a control rod drive mechanism housing and a weld portion between the stub tube and the bottom head of the reactor pressure vessel, which exists in the reactor pressure vessel of the boiling water nuclear power plant, the casing of the WJP apparatus and the high-pressure pump installed on the casing need to pass through a square opening portion formed in the top guide attached to the core shroud in the reactor pressure vessel and the circular opening portion formed in the core plate respectively.

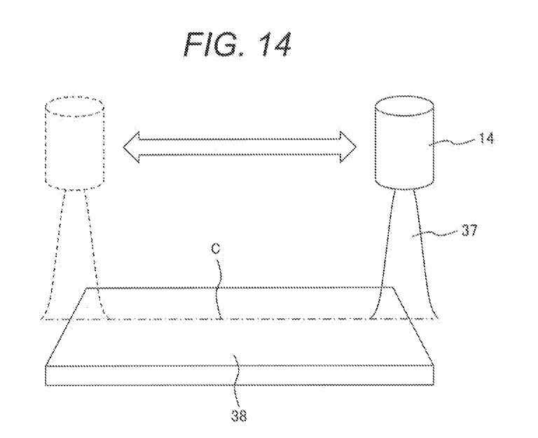

Therefore, the inventors executed an experiment for confirming whether a predetermined compressive residual stress can be given to the WJP execution object or not in the case that the required power of the high-pressure pump is made low. The contents of the experiment and the obtained experimental results will be explained by referring to FIGS. 14 to 18.

In the WJP experiment, as shown in FIG. 14, an injection nozzle 14 is disposed vertically to a test piece 39 made of stainless steel disposed in water, and high-pressure water pressurized by a high-pressure pump (not shown) is supplied to the injection nozzle 14, and the high-pressure water is jetted from the injection nozzle 14 toward the test piece 39. The high-pressure water flow jetted from the injection nozzle 14 is a cavitation jet including many cavities. The shock waves generated when the cavities included in the cavitation jet jetted from the injection nozzle 14 are collapsed impact on the surface of the test piece 39 in contact with water and the surface of the test piece 39 is finely deformed plastically. The plastic deformation generated on the surface of the test piece 39 is elastically restricted in the test piece 39 from the circumference, and thus, compressive residual stress is generated on the surface of the test piece 39. The injection nozzle 14 is scanned linearly along the surface of the test piece 39, so that the tensile residual stress is converted to compressive residual stress on the surface of the test specimen 39 and within a certain range on both sides around the WJP operation center C.

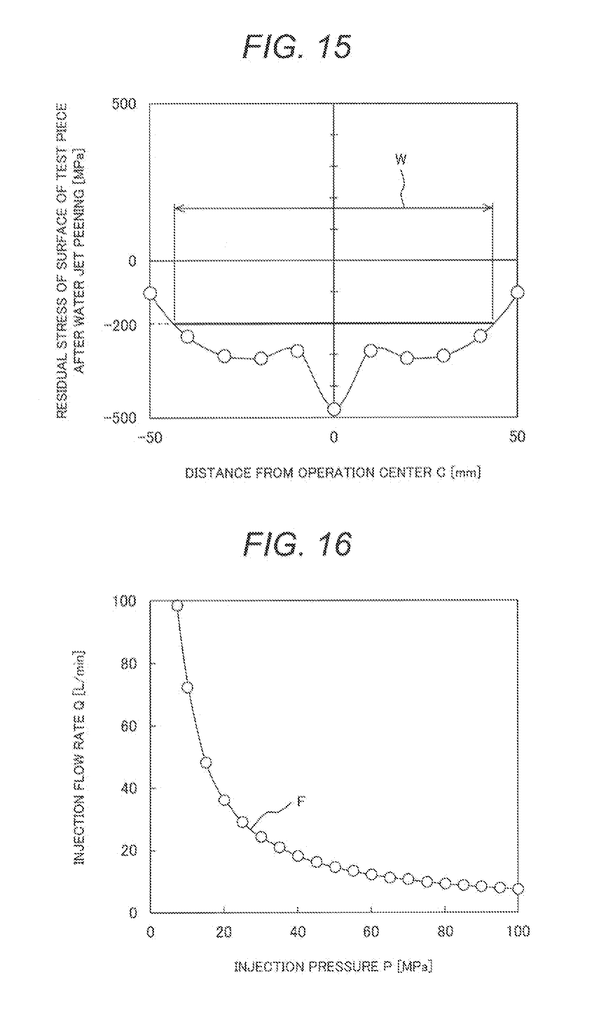

An example of the residual stress measurement results on the surface of the test piece 39 with the WJP executed by jetting high-pressure water from the injection nozzle 14 under the injection condition (the required power of the high-pressure pump is approximately 67 kW) in the conventional WJP execution operation is shown in FIG. 15. A vertical axis shown in FIG. 15 indicates the residual stress on the surface of the test piece 39 after the WJP execution, and a positive side indicates the tensile residual stress, and a negative side indicates the compressive residual stress. Assuming a range that the residual stress becomes compressive residual stress of −200 MPa or smaller as a width W of an effective WJP residual stress improvement on the surface of the test specimen 39, in the example shown in FIG. 15, a range of approximately 86 mm becomes the width W of the effective residual stress improvement.

The injection condition of the high-pressure water flow jetted from the injection nozzle 14 is expressed by the injection flow rate Q and the injection pressure P, and the required power E of the high-pressure pump is a function of the injection flow rate Q and the injection pressure P, which is expressed by Formula (1).

E=P×Q/(6.12×9.81×η) (1)

where η indicates a pump efficiency. Here, η is assumed as 0.8.

If the required power E of the high-pressure pump is fixed, the product of the injection flow rate Q and the injection pressure P is fixed, so that in the required power E of an arbitrary high-pressure pump, a plurality of choices are available in the combination of the injection flow rate Q and the injection pressure P. An example indicating a combination of the injection flow rate Q and the injection pressure P in a high-pressure pump of a required power of 15 kW is shown in FIG. 16. There exist a plurality of combinations of the injection flow rate Q and the injection pressure P from high pressure and low flow rate to low pressure and high flow rate on the performance curve F of the required power of 15 kW in the high-pressure pump.

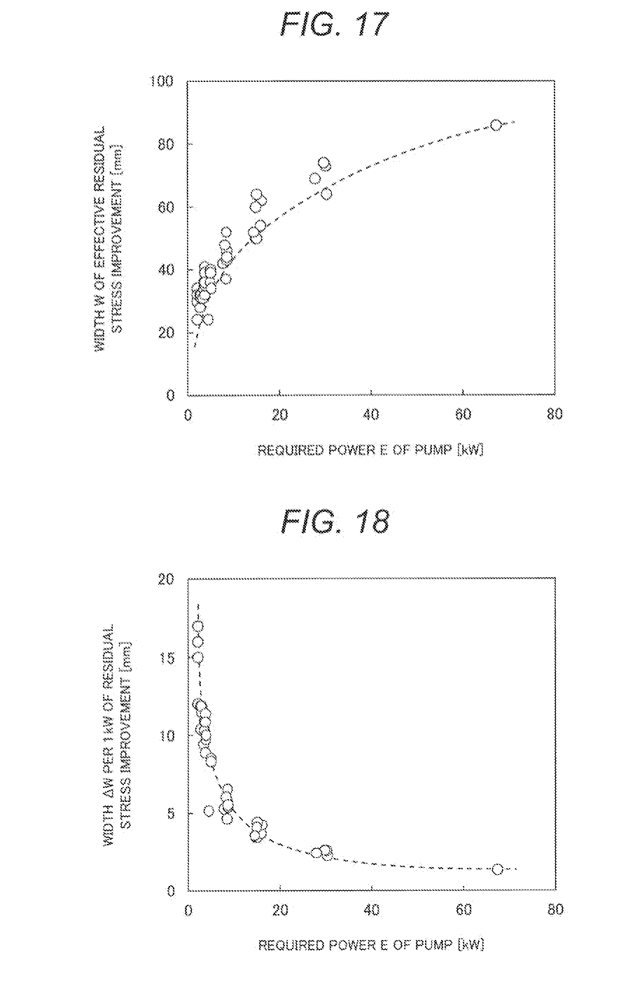

A relation between the required power E of the high-pressure pump and a width W of an effective residual stress improvement is shown in FIG. 17. The high-pressure water injection condition from the injection nozzle 14 in the conventional WJP execution operation is that the required power E of the high-pressure pump is approximately 67 kW. As shown in FIG. 17, it is found that as the required power E of the high-pressure pump decreases, the width W of the effective residual stress improvement reduces. In the high-pressure pump of the required power of 15 kW, the width W of the effective residual stress improvement is about 50 mm.

Furthermore, a relation between the required power E of the high-pressure pump and a width ΔW per 1 kW of the effective residual stress improvement when the width W of the effective residual stress improvement shown in FIG. 17 is divided by the required power E of the high-pressure pump at that time is shown in FIG. 18. In FIG. 18, a case that the required power E of the high-pressure pump is approximately 67 kW is an injection condition of the injection nozzle 14 in the conventional WJP execution operation. As shown in FIG. 18, as the required power E of the high-pressure pump decreases, the width ΔW per 1 kW of the effective residual stress improvement is related so as to increase and as the required power E of the high-pressure pump becomes smaller, the improvement efficiency for the compressive residual stress increases.

As mentioned above, the injection condition of the high-pressure water flow jetted from the injection nozzle 14 in the conventional WJP execution operation is equivalent to the case that a high-pressure pump of a required power E of approximately 67 kW is used. The width W of the effective residual stress improvement when the required power E of the high-pressure pump is approximately 67 kW is 86 mm, though for example, when the required power E of the high-pressure pump is approximately 15 kW smaller than ¼ thereof, the width W of the effective residual stress improvement is reduced to about 50 mm.

However, if the width W of the effective residual stress improvement is about 50 mm, the compressive residual stress can be given to the necessary widths of the weld portion and a heat-affected zone which are the WJP execution portion of the water jet peening operation object (the WJP execution object).

If the WJP execution objective portion requiring the width W of the effective residual stress improvement (for example, the width W of the effective residual stress improvement of 86 mm when the required power is 67 kW) wider than 50 mm exists, it is desirable, as described later, to use a plurality of WJP apparatuses where the high-pressure pump of a required power of 15 kW is installed in the casing in one WJP apparatus, carry out the WJP in the different WJP execution objective portions by the respective WJP apparatuses, then, so that the width W of the effective residual stress improvement will be a necessary width in the WJP execution objective portion in one of the WJP apparatuses, for the WJP execution objective portion, shift that one WJP apparatus in the direction of the width W of the effective residual stress improvement, and then scan once more, for example, in the opposite direction.

When use of power consumption equivalent to that in the case that one high-pressure pump of the required power E of approximately 67 kW is used is supposed, if the high-pressure pump is a high-pressure pump of the required power E of 15 kW, four high-pressure pumps can be used simultaneously. Therefore, when using a WJP apparatus where the high-pressure pump of the required power E of 15 kW is installed on the casing, the WJP for the WJP execution object can be executed using four WJP apparatuses simultaneously.

When the sum of the required power E (power consumption) of the high-pressure pump is fixed, by making the required power E of the high-pressure pump smaller and executing the WJP simultaneously for a plurality of portions of the WJP execution object using a plurality of WJP apparatuses with the high-pressure pump installed on the casing, the execution efficiency of the WJP operation can be improved.

The embodiments of the present invention with the above investigation results reflected to will be explained below.

### Embodiment 1

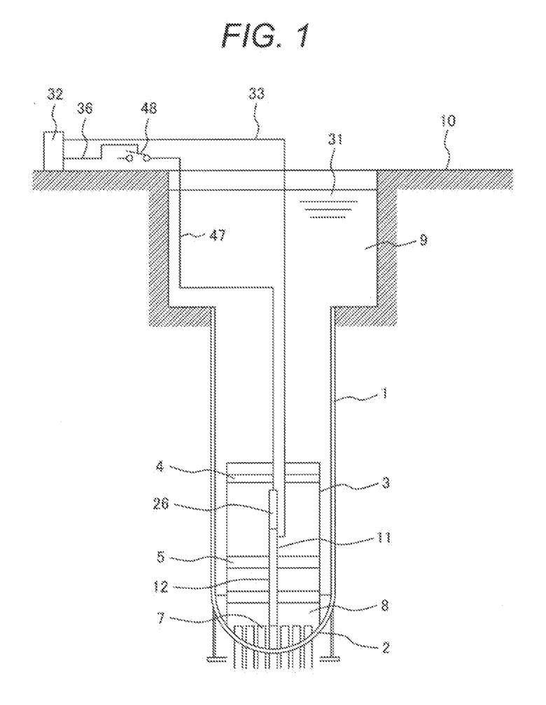

The water jet peening apparatus (the WJP apparatus) according to embodiment 1, which is a preferable embodiment of the present invention will be explained by referring to FIGS. 1, 2, 3, 4, and 5.

Schematic structure of a boiling water nuclear power plant in which water jet peening (WJP) is executed in the present embodiment will be explained by referring to FIG. 1. The boiling water nuclear power plant has a reactor pressure vessel 1. A cylindrical core shroud 3 is disposed in the reactor pressure vessel 1 and is installed in the reactor pressure vessel 1. A top guide 4 is attached to an upper portion of the core shroud 3 and a core plate 5 disposed below the top guide 4 and in the core shroud 3 is also installed on the core shroud 3. The core (not shown) loaded with a plurality of fuel assemblies (not shown) is enclosed by the core shroud 3. The top guide 4 supports the upper end of each fuel assembly loaded in the core. The core plate 5 holds a fuel support (not shown) for supporting the lower end of each fuel assembly. The zone below the core plate 5 in the reactor pressure vessel 1 is a low plenum 8.

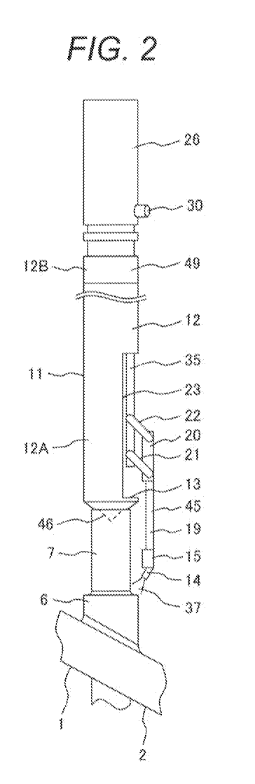

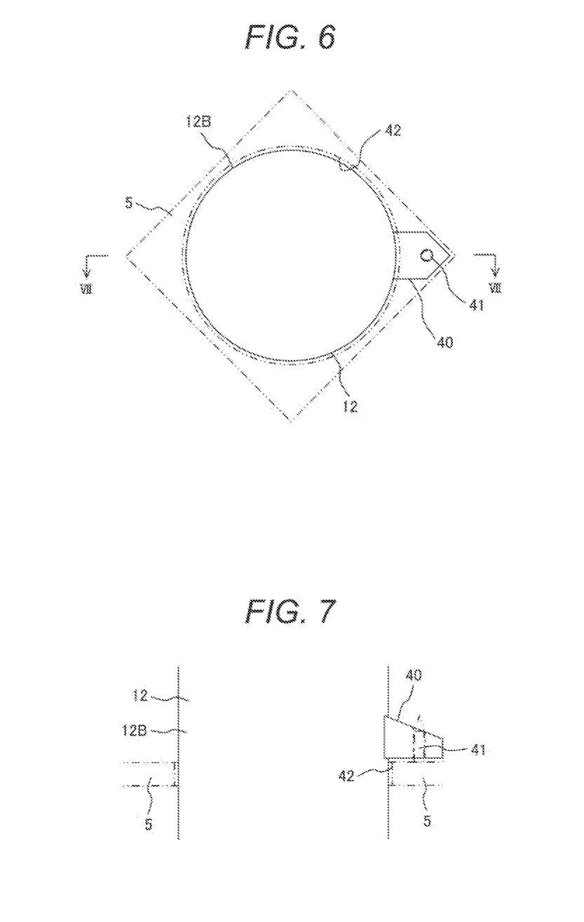

A plurality of control rod drive mechanism housings 7 are installed passing through a bottom head 2 of the reactor pressure vessel 1. Stub tubes 6 of the same number as that of the control rod drive mechanism housings 7 are attached to the inner surface of the bottom head 2 by welding (refer to FIG. 2). Each of the control rod drive mechanism housings 7 is inserted into separate stub tubes 6, is extended toward a lower position of the reactor pressure vessel 1, and is connected to the stub tubes 6 by welding. Each lower end of a plurality of control rod guide tubes (not shown) is joined to an upper end of each of the control rod drive mechanism housings 7 and each lower end portion of the fuel supports is inserted into each upper end of the control rode guides tube through each of circular openings 42 (refer to FIG. 6) formed in the core plate 5. Each positioning pin 41 (refer to FIG. 7) installed on a top surface of the core plate 5 is inserted into the through each hole formed in the fuel supports and prevents the revolution of each of the fuel support. An upper end of each of the control rod drive mechanism (not shown) installed in each of the control rod drive mechanism housings 7 is linked to an lower end of a control rod (not shown) disposed in each of the control rod guide tube. The control rod drive mechanism withdraws the linked control rod from the core and inserts it into the core, thereby controlling the reactor power.

A WJP apparatus 11 in the present embodiment, as shown in FIGS. 1 and 2, is provided with a casing 12, an injection nozzle 14, an injection nozzle drive mechanism (injection nozzle moving apparatus) 19, and a high-pressure under-water pump 26. The casing 12 includes a second casing 12B of a revolution mechanism 49 and a first casing 12A revolved below the revolution mechanism 49. The second casing 12B is positioned at an upper end portion of the casing 12.

One high-pressure under-water pump 26 is attached to an upper end of the cylindrical casing 12, that is, to an upper end of the second casing 12B. A sucking port 30 for sucking in water is installed on the high-pressure under-water pump 26. A sectional form of the high-pressure under-water pump 26 perpendicular to an axial center of the casing 12 is of a size capable of passing through a rectangular opening formed in the top guide 4. The sectional form of the casing 12 perpendicular to the axial center of the casing 12, concretely, the sectional forms of the first casing 12A and the second casing 12B are of the size capable of passing through the circular opening 42 formed in the core plate 5 which is smaller than the area of the rectangular opening formed in the top guide 4.

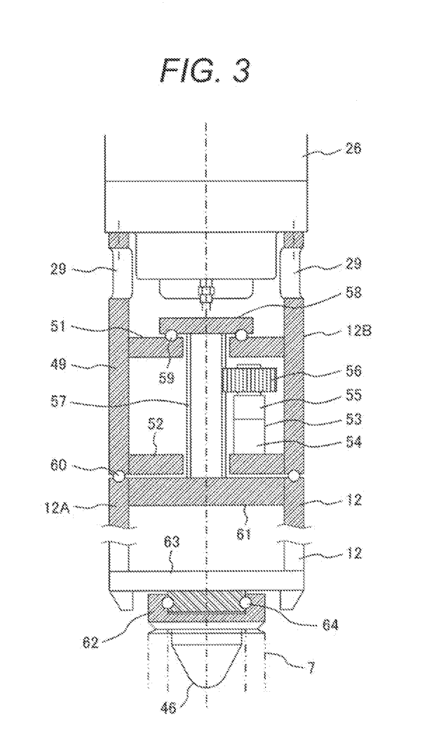

A structure of the revolution mechanism 49 will be explained by referring to FIG. 3. The revolution mechanism 49 has the second casing 12B and a turning apparatus 53. The second casing 12B is installed at the upper end of the first casing 12A rotatably by bearing 60. Ring-shaped support members 51 and 52 are disposed in the second casing 12B and are attached to an inner surface of the second casing 12B. The support member 52 is positioned at the lower end of the second casing 12B and the support member 51 is disposed above the support member 52.

The turning apparatus 53 has a motor 54, a decelerator 55, a gear 56, and a rotary shaft 57. The rotary shaft 57 with the gear formed on an outer surface is disposed passing through the respective centers of the support members 51 and 52 and an upper end of the rotary shaft 57 is attached to a bottom of a circular turning member 58 supported by the support member 51 rotatably by bearing 59. The rotary shaft 57 is supported by the support member 51. A lower end portion of the rotary shaft 57 is disposed in the first casing 12A and is attached to a support member 61 which is attached to an upper end of the first casing 12A. The motor 54 is installed on a top surface of the support member 52. The gear 56 is attached to a turning shaft of the decelerator 55 linked to the motor 54. The gear 56 meshes with the gear formed on the outer surface of the rotary shaft 57.

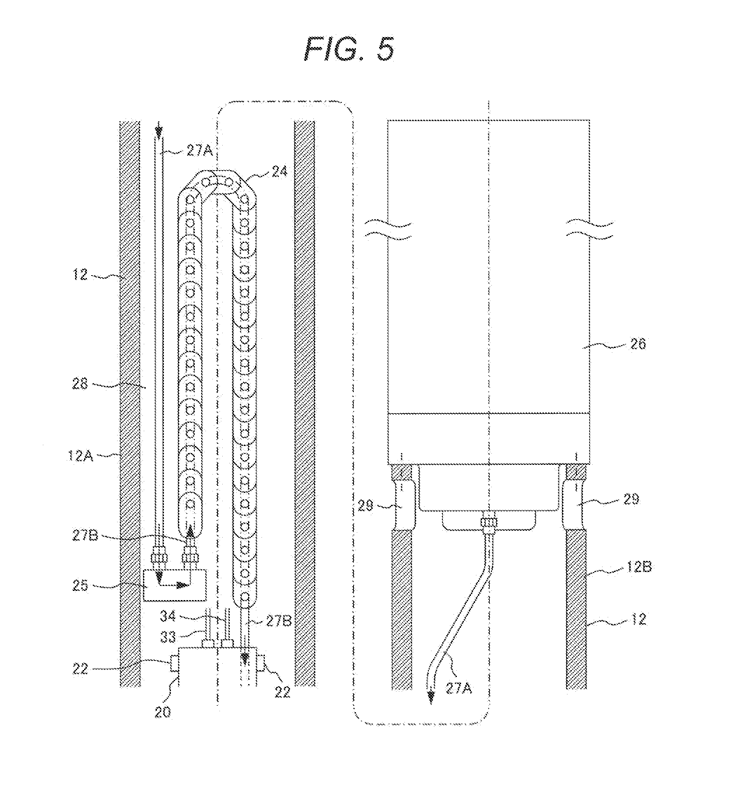

A plurality of openings 29 are formed at the upper end portion of the second casing 12B and pass through the second casing 12B (refer to FIGS. 3 and 5). A support member 40 is attached to the outer surface of the second casing 12B below the openings 29 (refer to FIG. 6). The through hole extending in the axial direction of the casing 12 is formed in the support member 40.

A bearing 62 is installed at a lower end of the casing 12, that is, at a lower end of the first casing 12A. The bearing 62 is attached to a support member 63 attached to the lower end of the first casing 12A rotatably by bearing 64.

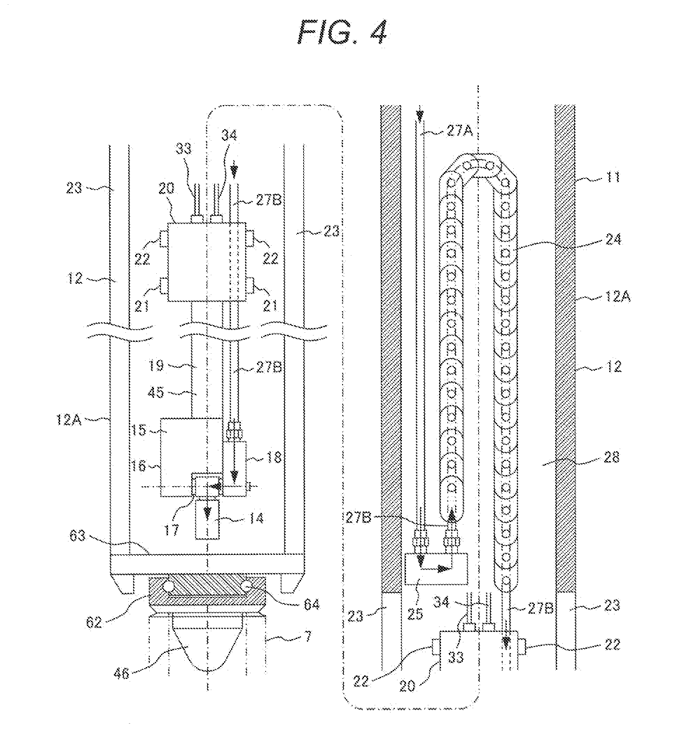

A projection 46 is installed at a lower end of the bearing 62 (refer to FIGS. 3 and 4) and extends toward a lower position of the first casing 12A. A sectional area of the projection 46 reduces as it separates from the lower end of the first casing 12A. An opening 13 (refer to FIG. 2) is formed at the lower end portion of the first casing 12A. The opening 13 extends in the axial direction of the casing 12. A symbol 23 indicates an end face in the peripheral direction of the first casing 12A which is generated by formation of the opening 13.

The injection nozzle drive mechanism 19 has a swivel unit 15, a relaying box 20, an elevating table 35, and an arm member 45 (refer to FIGS. 2 and 4). An upper end portion of the elevating table 35 is attached to a support plate (not shown) having a ball nut mating with a ball screw (not shown) installed in the first casing 12A. Both ends of the ball screw are attached to the inner surface of the first casing 12A rotatably by the bearings and a rotary shaft of the motor installed on the inner surface of the first casing 12A is linked to one end of the ball screw. A lower end of the laminar elevating table 35 extending in an axial direction of the first casing 12A is positioned at the opening 13. The respective one ends of paired links 21 and paired links 22 are attached to the lower end of the elevating table 35 separately rotatably by the rotary shaft. The rotary shaft to which the paired links 21 attached is attached rotatably to the elevating table 35 and is rotated by the motor (not shown) installed in the elevating table 35. The respective another ends of the paired links 21 and the paired links 22 are attached to the relaying box 20 separately rotatably by the rotary shafts. These rotary shafts are attached rotatably to the relaying box 20. One end of the arm member 45 is attached to the relaying box 20 and another end of the arm member 45 is attached to a casing 16 of the swivel unit 15 disposed below the relaying box 20. The arm member 45 and the swivel unit 15 are disposed outside the casing 12.

The injection nozzle 14 is attached to a rotary shaft 17 rotatably attached to the casing 16. The rotary shaft of the motor (not shown) installed in the casing 16 is linked to the end of the rotary shaft 17 on the side of the casing 16 via the decelerator (not shown). The other end of the rotary shaft 17 is inserted into a water reception portion 18 attached to the side of the casing 16 and is attached rotatably to a water reception portion 18. The interval between the water reception portion 18 and the rotary shaft 17 is sealed to prevent a water leak. The high-pressure water supply path (not shown) from an end of the water reception portion 18 side of the rotary shaft 17 to the injection nozzle 14 is formed in the rotary shaft 17. The high-pressure water supply path is connected with the water flow-in zone in the water reception portion 18.

A relaying block 25 is fixed in the first casing 12A at a position above the relaying box 20. Another high-pressure water supply path (not shown) is formed also in the relaying block 25. A high-pressure hose 27A is disposed in the casing 12 (the first casing 12A and the second casing 12B), and one end of the high-pressure hose 27A is connected to the high-pressure under-water pump 26, and another end of the high-pressure hose 27A is connected to the relaying block 25 (refer to FIGS. 4 and 5). The high-pressure hose 27A is communicated with the high-pressure water supply path formed in the relaying block 25.

A high-pressure hose 27B passes through the relaying box 20, and one end of the high-pressure hose 27B is connected to the relaying block 25, and another end of the high-pressure hose 27B is connected to the water reception portion 18 (refer to FIG. 4). The high-pressure hose 27B communicates with the high-pressure water supply path formed in the relaying block 25 and the water flow-in zone in the water reception portion 18. The high-pressure hose 27B is attached to a cable veyor (registered trademark) 24 which is formed in a reverse U shape.

A power supply cable 34 is connected to the relaying box 20 passing through the casing 12. The cable 34 is connected to the aforementioned motor installed in the casing 16 via a first switch (not shown) installed in the relaying box 20. A control cable 33 connected to a control apparatus 32 installed on an operating floor 10 is also connected to the relaying box 20 passing through the casing 12 and is connected to the first switch. A power supply cable 47 is connected to the high-pressure under-water pump 26 via a second switch 48 disposed on the operating floor 10. A control cable 36 connected to the control apparatus 32 is connected to the second switch 48.

A water jet peening method using the WJP apparatus 11 will be explained below. The WJP execution object in the water jet peening method is, for example, the control rod drive mechanism housing 7 and the WJP execution objective portion is, for example, a weld portion between the stub tube 6 and the control rod drive mechanism housing 7.

The operation of the boiling water nuclear power plant in a certain operation cycle is stopped and the periodic inspection of the boiling water nuclear power plant is executed. When starting the periodic inspection, the closure head of the reactor pressure vessel 1 is removed and cooling water is filled in the reactor pressure vessel 1 and a reactor well 9. The steam dryer (not shown) and steam separator (not shown) in the reactor pressure vessel 1 are removed and are transferred outside the reactor pressure vessel 1. The fuel assemblies in the core are taken out from the reactor pressure vessel 1 and are stored in the fuel storage pool (not shown). The fuel support, control rods, and control rod guide tubes are sequentially taken out from the reactor pressure vessel 1.

The WJP apparatus 11 hanged by a ceiling crane (not shown) in the reactor building descends in the reactor well 9 filled with cooling water 31 and reaches inside the reactor pressure vessel 1. The WJP apparatus 11 descending in the reactor pressure vessel 1 passes through the opening formed in the top guide 4. In accordance with the descent of the WJP apparatus 11, the lower end of the casing 12 of the WJP apparatus 11 descends below the core plate 5 through the opening 42 formed in the core plate 5 with the fuel support inserted. The lower end portion of the casing 12 is seated down at the upper end of one control rod drive mechanism housing 7 which is the WJP execution object. In FIG. 2, the swivel unit 15 of the WJP apparatus 11, the relaying box 20, and the arm member 45 are shown in the state that they are projected outside the outer surface of the first casing 12A, though these members are stored in the first casing 12A so as to pass through the opening 42 of the core plate 5 together with the first casing 12A.

When the bearing 62 attached to the lower end of the casing 12 is seated down at the upper end of the control rod drive mechanism housing 7, the projection 46 installed at the lower end of the casing 12 is inserted into the upper end of the control rod drive mechanism housing 7 (refer to FIGS. 3 and 4). Further, the support member 40 installed in the second casing 12B which is the upper end of the casing 12 is disposed on the top surface of the core plate 5 and the positioning pin 41 installed on the top surface of the core plate 5 is inserted into the through hole formed in the support member 40 (refer to FIGS. 6 and 7). The positioning pin 41 is joined to the support member 40, thus the misalignment of the casing 12, that is, the rotation of the casing 12 is prevented.

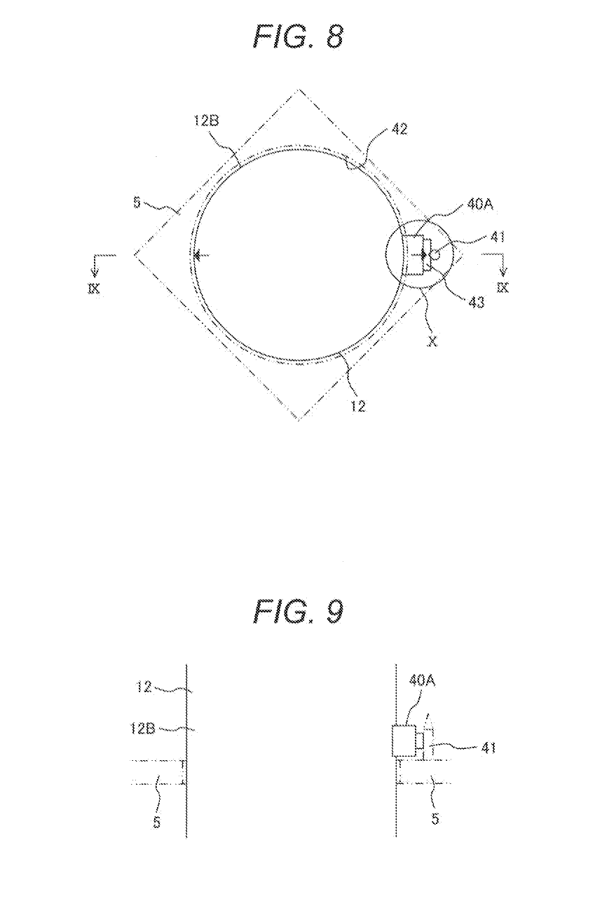

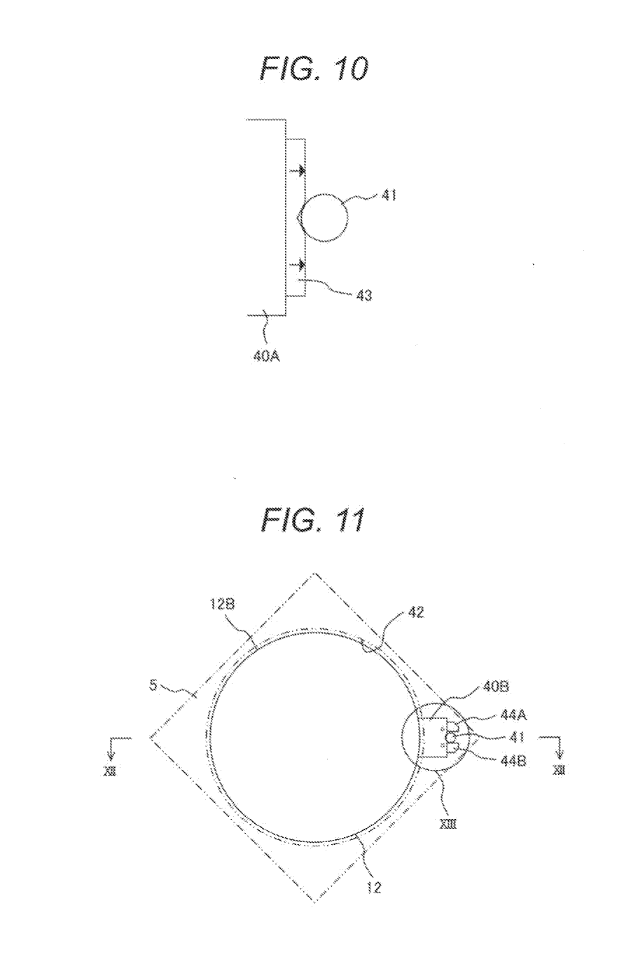

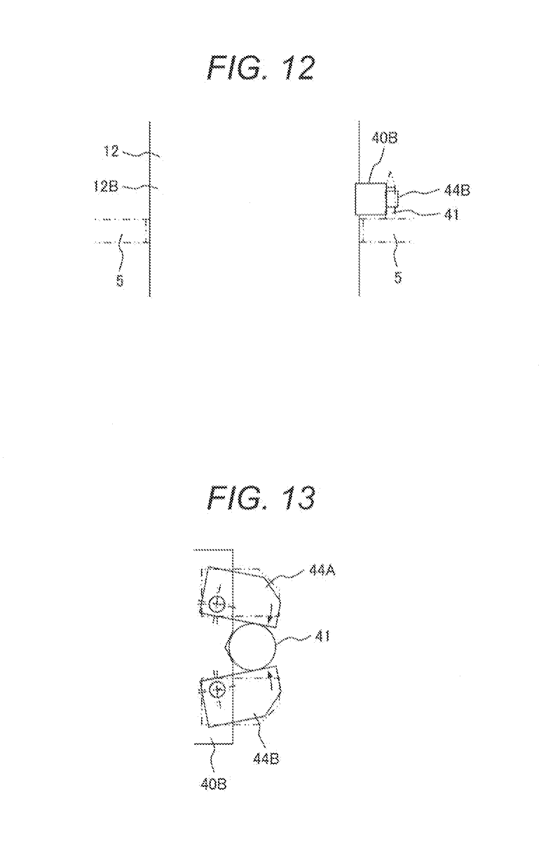

As a mechanism for preventing the rotation of the casing 12, a rotation prevention mechanism shown in FIGS. 8, 9, and 10 or a rotation prevention mechanism shown in FIGS. 11, 12, and 13 may be used except the rotation prevention mechanism shown in FIGS. 6 and 7.

The rotation prevention mechanism shown in FIGS. 8, 9, and 10 has a structure that a cylinder (not shown) is installed on a support member 40A installed in the second casing 12B and a pressing member 43 is attached to a piston installed in the cylinder. When the casing 12 of the WJP apparatus 11 is seated down at the upper end of the control rod drive mechanism housing 7, the pressing member 43 of the support member 40A placed on the top surface of the core plate 5 is disposed face to face with the positioning pin 41 installed on the core plate 5. If compressed air is supplied into the cylinder of the support member 40A, the pressing member 43 moves toward the positioning pin 41 and is pressed to the positioning pin 41. At this time, the outer surface of the second cylinder 12B on the opposite side of 180° to the position of the support member 40A is pressed against the inner surface of the opening 42, thus the rotation of the second cylinder 12B is prevented.

The turning prevention mechanism shown in FIGS. 11, 12, and 13 has a cylinder mechanism for attaching holding members 44A and 44B rotatably to the support member 40B installed in the second cylinder 12B and rotating these holding members. The cylinder mechanism is installed on the support member 40B. When the casing 12 of the WJP apparatus 11 is seated down at the upper end of the control rod drive mechanism housing 7, the positioning pin 41 installed on the core plate 5 is disposed between the holding member 44A and the holding member 44B of the support member 40B placed on the top of the core plate 5. If compressed air is supplied to the cylinder mechanism, the holding member 44A rotates clockwise in FIG. 13 and the holding member 44B rotates counterclockwise in FIG. 13. Then, the holding members 44A and 44B make contact with the outer surface of the positioning pin 41 and the positioning pin 41 is held by the holding members 44A and 44B. Therefore, the rotation of the second cylinder 12B is prevented.

The drive and stop of the high-pressure under-water pump 26 are controlled by turning the second switch 48 ON or OFF by a control signal outputted from the control apparatus 32 to a control cable 36. The positioning of the injection nozzle 14 in the axial direction of the casing 12 and an injection angle of the injection nozzle 14 for the control rod drive mechanism housing 7 which is the WJP execution object are controlled by a control signal outputted from the control apparatus 32 to a control cable 33.

The positioning of the injection nozzle 14 in the axial direction of the casing 12 is executed by moving the injection nozzle 14 in the axial direction of the casing 12 by the injection nozzle drive mechanism 19. Namely, if the ball screw installed in the first casing 12A is rotated by the motor, the plate including the ball nut engaging with the ball screw moves in the axial direction of the first casing 12A and the elevating table 35 and the arm member 45 also move in the axial direction of the first casing 12A. By this movement, the jet outlet of the injection nozzle 14 is positioned in the neighborhood of the outer surface of the weld portion between the control rod drive mechanism housing 7, which is the WJP execution portion, and the stub tube 6. When the elevating table 35 and the arm member 45 move in the axial direction of the first casing 12A, in association with this movement, the position of the peak of the cable veyor 24 disposed in a reverse U shape in the first casing 12A also moves in the axial direction. When the WJP execution portion is the weld portion between the stub tube 6 and the reactor pressure vessel 1, the elevating table 35 and the arm member 45 are further descended by the rotation of the ball screw, and the jet outlet of the injection nozzle 14 is fit to the position of the weld portion between the stub tube 6 and the reactor pressure vessel 1.

The positioning of the injection nozzle 14 in the horizontal direction is executed as shown below. The motor installed in the elevating table 35 is rotated to rotate the rotary shaft to which the respective one ends of the paired links 21 are attached. By doing this, the paired links 21 are rotated in the axial direction of the first casing 12A and the relaying box 20 is moved so as to approach (or separate from) the first casing 12A. Further, when the paired links 21 rotate, the paired links 22 which are driven links rotate similarly to the links 21. Even by this rotation of the paired links 21 and 22, the arm member 45 is held in the parallel state to the elevating table 35. The paired links 21 and paired links 22 structure the parallel link mechanism. As a result, the injection nozzle 14 attached to the swivel unit 15 moves in the horizontal direction and the horizontal distance between the jet outlet of the injection nozzle 14 and the WJP execution portion (the weld portion between the control rod drive mechanism housing 7 and the stub tube 6) can be fit to a predetermined distance.

The first switch is closed by a control signal outputted from the control apparatus 32 to the control cable 33, so that the motor installed in the casing 16 is driven, and then the injection angle of the injection nozzle 14 to the control rod drive mechanism housing 7 is adjusted. That is, when the first switch is closed, the power supplied through the cable 34 rotates the motor. The rotary shaft 17 rotates, thus the injection nozzle 14 is rotated around the rotary shaft 17. When the jet outlet of the injection nozzle 14 is directed toward the weld portion between the control rod drive mechanism housing 7 and the stub tube 6, the first switch is opened and the rotation of the rotary shaft 17 by the motor is stopped. The status of the injection nozzle 14 is monitored by a monitoring camera (not shown) installed to the first casing 12A.

When the control signal is outputted from the control apparatus 32 to the control cable 36, the second switch 48 is closed. The power is supplied to the high-pressure under-water pump 26 through the cable 47 and the high-pressure under-water pump 26 is driven. The cooling water 31 in the reactor pressure vessel 1 is sucked in from the sucking port 30 and is pressurized by the high-pressure under-water pump 26. The high-pressure water discharged from the high-pressure under-water pump 26 is supplied to the injection nozzle 14 through the high-pressure hose 27A, the high-pressure water supply path in the relaying block 25, the high-pressure hose 27B, the water flow-in zone in the water reception portion 18, and the high-pressure water supply path in the rotary shaft 17. This high-pressure water is jetted from the injection nozzle 14 as the cavitation jet 37 including fine numberless cavities. The shock waves generated when the cavities included in the cavitation jet 37 are collapsed impact on the surface of the weld portion between the control rod drive mechanism housing 7 and the stub tube 6. By doing this, compressive residual stress is given to the surface of the weld portion.

The weld portion between the control rod drive mechanism housing 7 and the stub tube 6 exists along the entire perimeter of the control rod drive mechanism housing 7, so that when executing the WJP along the entire perimeter of the weld portion, the injection nozzle 14 jetting the cavitation jet 37 needs to be rotated around the control rod drive mechanism housing 7 along the weld portion. The rotation of the injection nozzle 14 is executed using the turning apparatus 53. When the motor 54 is driven, the turning force of the motor 54 is transferred to the gear 56 via the decelerator 55 and the gear 56 is rotated. Therefore, the rotary shaft 57 is rotated by the gear 56 and the first casing 12A rotates. By the rotation of the first casing 12A, the injection nozzle 14 jetting the cavitation jet 37 rotates around the control rod drive mechanism housing 7 and moves along the weld portion. The motor 54 repeats alternately the normal rotation and the reverse rotation to prevent the high-pressure hose 27A and the control cables 33 and 34 from torsion. Therefore, the injection nozzle 14 repeats the clockwise rotation of 180° and the counterclockwise rotation of 180° around the control rod drive mechanism housing 7 while jetting the cavitation jet 37. In this way, the compressive residual stress can be given to the surface of the weld portion and the surface of the heat affected zone along the entire perimeter of the weld portion between the control rod drive mechanism housing 7 and the stub tube 6. Further, when the motor 54 is driven, the second casing 12B and the high-pressure under-water pump 26 do not rotate.

According to the present embodiment, the high-pressure under-water pump 26 is installed on the casing 12 which is the structural member of the WJP apparatus 11 wherein the injection nozzle 14 is installed, so that the high-pressure hoses 27A and 27B for supplying high-pressure water from the high-pressure under-water pump 26 to the injection nozzle 14 can be disposed in the WJP apparatus 11, concretely, in the casing 12. Therefore, the WJP apparatus 11 in the reactor well 9 and the reactor pressure vessel 1 can be moved quickly and the time required for setting the WJP apparatus 11 in the position of the WJP execution object can be shortened remarkably.

In the water jet peening method described in Japanese Patent No. 2859125, the length of the high-pressure hose for connecting the high-pressure pump installed on the operating floor and the injection nozzle becomes 50 to 100 m or so, and the movement of the casing 12 of the WJP apparatus with the injection nozzle installed up to the WJP execution objective portion requires a long period of time under restrictions by the high-pressure hose hardly bent due to high strength. However, in the present embodiment, the high-pressure under-water pump 26 is attached on the casing 12, so that the WJP apparatus 11 can be moved quickly without the movement of the WJP apparatus 11 being restricted by the high-pressure hose as in Japanese Patent No. 2859125.

In the present embodiment, after end of the WJP operation for the WJP execution object, the time required for collecting the WJP apparatus 11 until the operating floor also can be shortened.

Therefore, the present embodiment can shorten remarkably the time required for WJP execution operation.

The high-pressure under-water pump 26 is installed on the upper end of the casing 12, so that in the boiling water nuclear power plant, the WJP apparatus 11 can pass easily through the opening formed in the top guide 4.

Further, in the water jet peening method described in Japanese Patent No. 2859125, the pressure loss by the high-pressure hose of 50 to 100 m long is about 10 MPa. As a consequence, in the conventional water jet peening method, the operation efficiency of the high-pressure pump is reduced by the pressure loss of the high-pressure hose, so that expecting a pressure loss of the high-pressure hose, the specification of the high-pressure pump needs to be set. In the present embodiment, the total length of the high-pressure hoses 27A and 27B disposed in the casing 12 becomes very short compared with conventional 50 to 100 m. Therefore, the pressure loss by the high-pressure hose is reduced remarkably and the operation efficiency of the high-pressure under-water pump 26 can be heightened.

In the present embodiment, the high-pressure hoses 27A and 27B for connecting the high-pressure under-water pump 26 and the injection nozzle 14 are disposed in the casing 12 and the portion of the high-pressure hose 27B disposed outside the casing 12 is also attached to the cable veyor 24, so that the passing of the WJP apparatus 11 through the opening formed in the top guide 4 and the opening 42 of the core plate 5 can be executed smoothly and the time required for WJP execution operation can be further shortened.

In the present embodiment, the cooling water 31 in the reactor pressure vessel 1 which is pressurized by the high-pressure under-water pump 26 is jetted toward the WJP execution objective portion in the reactor pressure vessel 1 from the injection nozzle 14. In this way, in the present embodiment, when executing the WJP, the cooling water 31 in the reactor pressure vessel 1 is circulated and can be jetted from the injection nozzle 14. Therefore, the control of the cooling water supplied to the injection nozzle 14 is unnecessary.

In the present embodiment, the WJP apparatus 11 in which the high-pressure under-water pump 26 is installed on the casing 12 equipped with the injection nozzle 14 is used for the WJP execution operation in the reactor pressure vessel 1, so that a plurality of WJP apparatuses 11 are seated separately at the respective upper ends of a plurality of control rod drive mechanism housings 7 and the WJP execution operation for the weld portion of the plurality of control rod drive mechanism housings 7 can be executed in parallel. By doing this, the WJP execution operation for all the control rod drive mechanism housings 7 installed in the reactor pressure vessel 1 can be finished in a shorter period of time. Further, when using the WJP apparatus 11 in which the high-pressure under-water pump 26 is installed on the casing 12, the number of WJP apparatuses 11 used at one time can be increased easily.

The high-pressure pump used in the aforementioned conventional WJP execution operation, a high-pressure pump of a required power of approximately 100 kW is used in consideration of the pressure loss of a long high-pressure hose, so that a temporary power source of a voltage of 440 V is necessary as a power source for supplying power to the high-pressure pump. However, in the present embodiment, since the high-pressure under-water pump 26 is installed on the casing 12, if the required power of the high-pressure under-water pump 26 is 22 kW or lower, the supply voltage to the high-pressure under-water pump 26 may be 200 V. Therefore, if the required power of the high-pressure under-water pump 26 is set to 22 kW or lower, the additional installation work of a 200 V power source in the reactor building may be executed and the conventional temporary power source work is unnecessary.

The WJP may be executed for the surface of the weld portion between the stub tube 6 and the end plate 2 of the reactor pressure vessel 1 using the WJP apparatus 11.

### Embodiment 2

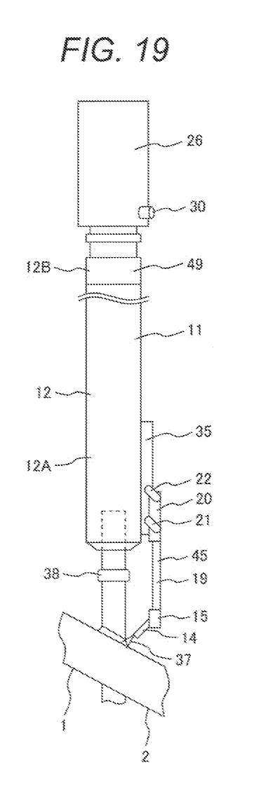

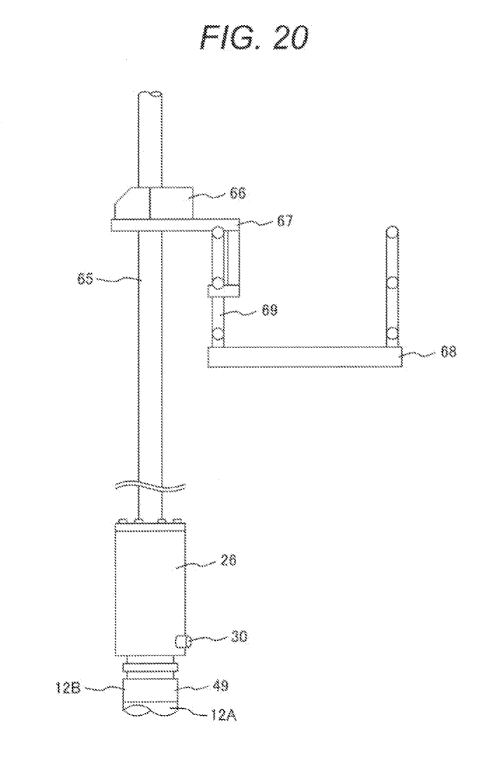

A water jet peening method according to embodiment 2 which is another preferable embodiment of the present invention will be explained by referring to FIGS. 19 and 20. The present embodiment is the water jet peening method for executing the WJP for the surface of the weld portion between an in-core guide tube 38 disposed in the reactor pressure vessel 1 of a pressurized water reactor and a bottom head 2 of the reactor pressure vessel 1 using the WJP apparatus 11 of embodiment 1. The WJP execution object in the present embodiment is the in-core guide tube 38.

In the periodic inspection term after operation stop of the pressurized water reactor, the closure head of the reactor pressure vessel 1 is removed and all the fuel assemblies loaded in the core are taken out from the reactor pressure vessel 1. The reactor internal for supporting the core is also taken out from the reactor pressure vessel 1. The reactor pressure vessel 1 is filled with cooling water.

The WJP apparatus 11 with a support attached at the upper end portion thereof and with the high-pressure under-water pump 26 installed on the upper end of the casing 12 is hanged by the ceiling crane, and the injection nozzle 14 is descended down in the reactor pressure vessel 1 until it reaches in the neighborhood of the weld portion between the in-core guide tube 38 which is the WJP execution object and the bottom head 2 of the reactor pressure vessel 1. When the injection nozzle 14 is descended down in the neighborhood of the weld portion, the descent of the WJP apparatus 11 is stopped. A support holding member 66 to which a holding portion fixture 67 is attached is attached to a support 65 attached on the upper end of the casing of the high-pressure under-water pump 26 of the WJP apparatus 11. An operation carriage 68 is installed above the reactor pressure vessel 1 in the primary containment vessel (not shown) surrounding the reactor pressure vessel 1. The holding portion fixture 67 is supported by a handrail 69 of the operation carriage 68, thus the WJP apparatus 11 is held by the operation carriage 68. In this way, the WJP apparatus 11 is held by the operation carriage 68, thus the second casing 12B and the high-pressure under-water pump 26 are prevented from rotation.

Similarly to embodiment 1, after the injection nozzle 14 is positioned for the surface of the weld portion between the in-core guide tube 38 and the end plate 2 of the reactor pressure vessel 1, the high-pressure under-water pump 26 is driven. The cooling water in the reactor pressure vessel 1 flows into the high-pressure under-water pump 26 from the sucking-in port 30 and is pressurized by the high-pressure under-water pump 26. The pressurized cooling water becomes high-pressure water and is supplied to the injection nozzle 14 through the high-pressure hoses 27A and 27B installed in the casing 12. The cavitation jet 37 is jetted from the injection nozzle 14 toward the surface of the weld portion. Each cavity included in the cavitation jet 37 is collapsed and shock waves are generated. The shock waves impact with the surface of the weld portion, thus, compressive residual stress is given to the weld portion surface. The first casing 12A repeatedly rotates every 180° in the clockwise direction and counterclockwise direction and the injection nozzle 14 rotates around the in-core guide tube 38 by driving the motor 54, so that compressive residual stress can be given along the entire perimeter of the weld portion between the in-core guide tube 38 and the reactor pressure vessel 1.

The present embodiment can obtain each effect generated in embodiment 1.

### Embodiment 3

In embodiment 1, using the WJP apparatus in which the high-pressure pump is installed on the upper end of the casing, the WJP execution operation for the surface of the weld portion between the control rod drive mechanism housing 7 and the stub tube 6 is executed, though even the WJP execution operation can be executed for the weld portion of the core shroud between the top guide 4 and the core plate 5 for surrounding the core in the reactor pressure vessel 1.

The water jet peening method according to embodiment 3 which is other preferable embodiment of the present invention and in which the WJP execution operation is executed for the weld portion of the core shroud, will be explained below.

The WJP apparatus used in the water jet peening method of the present embodiment includes the casing 12 into which the first casing 12A and the second casing 12B are integrated in the WJP apparatus 11 and furthermore, the injection nozzle drive mechanism is different from the WJP apparatus 11. The transverse cross section of the cylindrical casing 12 is rectangular in correspondence to the rectangular opening formed in the top guide 4. The other structure of the WJP apparatus used in the present embodiment is the same as that of the WJP apparatus 11 and the first casing 12A does not rotate.

The nozzle drive mechanism of the WJP apparatus used in the present embodiment includes a ball screw, a first motor for rotating the ball screw, an elevating member attached to a ball nut engaging with the ball screw, a rail member, a back and forth drive apparatus attached to the elevating member for moving the rail member in the direction perpendicular to the ball screw, and a second motor. The rail member is attached to the elevating member so as to rotate within a range of 90° in a horizontal direction and a vertical direction and the second motor is an apparatus for rotating the rail member within the aforementioned range of 90° clockwise and counterclockwise. The injection nozzle 14 is installed movably on the rail of the rail member.

The ball screw is installed rotatably in the casing 12 and is extended from the lower end of the casing 12 up to the upper end of the casing 12 in the axial direction of the casing 12. The rotary shaft of the first motor installed at the upper end portion of the casing in the casing 12 is linked to the upper end of the ball screw via the decelerator. The ball nut to which the elevating member is attached mates with the ball screw. A guide bar for preventing the rotation of the elevating member in correspondence to the rotation of the ball screw is installed in the casing 12 passing through the elevating member and is disposed in parallel with the ball screw. Similarly to the WJP apparatus 11, one end of the high-pressure hose 27B attached to the cable veyor 24 is connected to the relaying block 25, and the other end of the high-pressure hose 27B is connected to the injection nozzle 14 attached to the rotation plate. The opening 13 formed in the casing 12 of the WJP apparatus used in the present embodiment extends from the lower end of the casing 12 to the neighborhood of the upper end of the ball screw unlike the WJP apparatus 11.

When executing the WJP for the weld portion of the core shroud 3 above the core plate 5, the aforementioned WJP apparatus (hereinafter referred to as the first WJP apparatus) used in the present embodiment is descended in the reactor pressure vessel 1 and descends in the rectangular opening formed in the top guide 4. When the first WJP apparatus passes through the opening of the top guide 4, the rail member is in the perpendicular state and is parallel to a center line of the casing 12. The lower end portion of the casing 12 is seated on a predetermined control rod guide tube (not shown) or core plate 5 and the upper end of the casing 12 is inserted into the rectangular opening formed in the top guide 4. The casing 12 having a rectangular cross section is inserted into the opening of the top guide 4, so that the casing 12 does not rotate.

After the first WJP apparatus is seated on the control rod guide tube or core plate 5, the second motor is driven, and the rail member is rotated, and the rail member is set in the horizontal state. At this time, the opening 13 of the casing 12 faces to the inner surface of the core shroud 3 and the jet outlet of the injection nozzle 14 installed movably on the rail installed on the rail member faces on the inner surface of the core shroud 3. The first motor is driven to rotate the ball screw and the elevating member is moved to a predetermined position in the axial direction of the casing 12. By the movement of the elevating member, the jet outlet of the injection nozzle 14 is positioned in the position of the weld portion of the WJP execution object in the axial direction of the casing 12.

Next, the back and forth drive apparatus installed in the elevating member is driven and the rail member is moved in the radial direction of the core shroud, thus, the distance between the jet outlet of the injection nozzle 14 and the inner surface of the core shroud, that is, the injection distance is adjusted to the set distance and the injection nozzle 14 is positioned in the radial direction of the core shroud.

The high-pressure under-water pump 26 is driven, thus the cooling water 31 in the reactor pressure vessel 1 is pressurized to high-pressure water, and the high-pressure water is supplied to the injection nozzle 14 through the high-pressure hoses 27A and 27B, and is jetted from the injection nozzle 14. The injection nozzle 14 jetting the cavitation jet is moved in the peripheral direction of the core shroud along the rail of the rail member. The rail member is formed in the fan shape in correspondence to the curvature of the inner surface of the core shroud, so that the injection nozzle 14 can be moved over a certain distance, for example, over a plurality of cells in the peripheral direction of the core shroud. The distance between the injection nozzle 14 for jetting the cavitation jet and the inner surface of the core shroud is adjusted by driving the back and forth drive apparatus so as to be made fixed. The injection nozzle 14 moves on the rail member at a predetermined distance in the peripheral direction of the core shroud while jetting the cavitation jet which is high-pressure water toward the inner surface of the weld portion of the core shroud 3. Each cavity included in the cavitation jet is collapsed and shock waves are generated. Each of the generated shock waves impact with the inner surface of the weld portion of the core shroud 3 and compressive residual stress is given to its inner surface. Due to the rotation of the rotation plate equipped with the injection nozzle 14, the compressive residual stress is given to the inner surface of the weld portion within a predetermined angle range in the peripheral direction of the core shroud 3. After the compressive residual stress is given to the inner surface of the weld portion within a predetermined distance range in the peripheral direction of the core shroud, the first WJP apparatus used in the present embodiment is moved upward, is pulled out from the opening of the top guide 4, is moved in the peripheral direction of the core shroud 3 above the top guide 4, is descended down via a predetermine another opening, and is seated on another control rod guide tube or core plate 5. At this position, as mentioned above, the injection nozzle 14 is moved in the peripheral direction of the core shroud while jetting the cavitation jet from the injection nozzle 14. As a result, the compressive residual stress is given to the inner surface of the weld portion within the next predetermined angle range continuously to the inner surface of the weld portion to which the aforementioned compressive residual stress was given. As mentioned above, the first WJP apparatus is seated sequentially in the control rod guide tube adjacent in the peripheral direction of the core shroud 3, and the cavitation jet is jetted within the predetermined angle range, thus the compressive residual stress can be given continuously along the entire perimeter of the inner surface of the weld portion extending in the peripheral direction of the core shroud 3.

Further, in the present embodiment, when executing the WJP for the inner surface of the weld portion of the core shroud 3 below the core plate 5, the projection 46 at the lower end of the casing 12 of the second WJP apparatus is inserted into the opening 42 of the core plate 5 and the lower end of the casing 12 is seated down at the upper end of one control rod drive mechanism housing 7 The upper end of the casing 12 is inserted into the opening of the top guide 4 and is supported by the top guide 4. The high-speed under-water pump 26 installed on the upper end of the casing 12 is disposed above the top guide 4. The WJP using the second WJP apparatus is executed for the inner surface of the weld portion of the core shroud 3 similarly to the WJP using the first WJP apparatus.

Furthermore, in the present embodiment, the WJP for the weld portion between the control rod drive mechanism housing 7 and the stub tube 6 can be executed in parallel with the execution of WJP for the core shroud 3 by use of the WJP apparatus 11 used in embodiment 1.

The present embodiment can obtain each effect generated in embodiment 1.

### REFERENCE SIGNS LIST

1: reactor pressure vessel, 3: core shroud, 4: top guide, 5: core plate, 6: stub tube, 7: control rod drive mechanism housing, 11: water jet peening apparatus, 12: casing, 14: injection nozzle, 15: swivel unit, 19: injection nozzle drive mechanism, 20: relaying box, 24: cable veyor, 26: high-pressure under-water pump, 27A, 27B: high-pressure hose, 38: in-core guide tube.

What is claimed is:

1. A water jet peening apparatus comprising:
a casing; a high-pressure under-water pump installed on said casing; an injection nozzle to which water pressurized by said high-pressure under-water pump is supplied; and an injection nozzle moving apparatus installed in said casing for moving said injection nozzle.

2. The water jet peening apparatus according to claim 1, wherein a high-pressure hose connected to said high-pressure under-water pump and said injection nozzle is disposed in said casing.

3. The water jet peening apparatus according to claim 1, wherein said high-pressure under-water pump is installed on an upper end of said casing.

4. The water jet peening apparatus according to claim 2, wherein said high-pressure under-water pump is installed on an upper end of said casing.

5. A water jet peening method comprising the steps of:
disposing a water jet peening apparatus having a casing, a high-pressure under-water pump installed on said casing, an injection nozzle to which water pressurized by said high-pressure under-water pump is supplied, and an injection nozzle moving apparatus installed in said casing for moving said injection nozzle, in cooling water filled in a reactor pressure vessel;
pressurizing said cooling water by said high-pressure under-water pump; and
jetting said pressurized cooling water from said injection nozzle into said cooling water toward a water jet peening execution object in said reactor pressure vessel.

6. The water jet peening method according to claim 5, wherein said cooling water pressurized by said high-pressure under-water pump is supplied to said injection nozzle through a high-pressure hose disposed in said casing and connected to said high-pressure under-water pump and said injection nozzle.

7. The water jet peening method according to claim 5, comprising the step:
using said water jet peening apparatus in which said high-pressure under-water pump is installed on an upper end of said casing.

8. The water jet peening method according to claim 5, comprising the step:
using a plurality of said water jet peening apparatus; and
executing said water jet peening to different water jet peening execution portions of said water jet peening execution object in parallel by said plurality of water jet peening apparatus.

9. The water jet peening method according to claim 6, comprising the step:
using a plurality of said water jet peening apparatus; and
executing said water jet peening to different water jet peening execution portions of said water jet peening execution object in parallel by said plurality of water jet peening apparatus.

10. The water jet peening method according to claim 5, wherein water jet peening using said water jet peening apparatus is executed for said water jet peening execution object in said reactor pressure vessel of either a boiling water reactor or a pressurized water reactor.
